(19) United States
(12) Patent Application Publication
(10) Pub. No.: US 2023/0259884 A1
(43) Pub. Date: Aug. 17, 2023

(54) TARGETING TECHNIQUES FOR PROMOTED JOB POSTINGS

(71) Applicant: Microsoft Technology Licensing, LLC, Redmond, WA (US)

(72) Inventors: Wen Pu, Santa Clara, CA (US); Yuchin Juan, Fremont, CA (US); Ping Liu, Miami, FL (US); Kun Tian, Sunnyvale, CA (US); Dawei Wang, Fremont, CA (US)

(21) Appl. No.: 17/674,695

(22) Filed: Feb. 17, 2022

(51) Int. Cl. G06Q 10/10

(52) U.S. Cl. CPC G06Q 10/1053

(57) ABSTRACT

Described herein is a technique for deriving and using a member profile-to-job posting graph that includes a plurality of implicit facets that map member profiles to job postings. Each implicit facet is a combination of member profile attributes linked with job profile attributes, such that a member profile is linked to the implicit facet when the member profile has member profile attribute values that match those of the implicit facet, and a job posting is linked to the implicit facet when the job posting has job attribute values that match those of the implicit facet. Using the graph, information about the potential applicant pool for a new job posting can be derived and presented to the person who is creating the new job posting.

### TECHNICAL FIELD

The present application generally relates to a service offering provided by an online or web-based job hosting service, which is known and referred to in the art as a paid job posting or promoted job posting. Specifically, the present application relates to a data processing framework and technique used in matching online job postings with member profiles of members of a job hosting service, particularly when the online job postings are subject to a pay-for-performance model.

### BACKGROUND

An online or web-based job hosting service is an Internet-enabled service that allows those who are seeking employees to create and post online job postings that describe available job opportunities, while simultaneously allowing those seeking job opportunities to search for and browse recommended online job postings. One of the fundamental ways in which online job hosting services operate is by performing some type of matching between characteristics or attributes of a job opportunity as expressed by the various data fields of the online job posting, with characteristics or attributes of a job-seeking member, as may be embodied in a member profile associated with the job-seeking member. Online job hosting services tend to use these matching algorithms in both recommendation systems as well as search engines. For instance, the matching of job postings to a member, or the matching of members to a job posting, occurs in several different contexts, some of which involve recommendation systems, and in other instances, search engines.

Many online job hosting services offer a job posting service that involves a pay-for-performance model. For example, when a job-posting member is providing information to generate a job posting, the job-posting member may be prompted to pay a fee, or provide a bid for an auction-based system, and in exchange for the fee or bid, the job posting will receive certain beneficial handling or processing via the job hosting service. For example, when a job-seeking member performs a search for relevant job postings, a pay-for-performance job posting, referred to herein as a paid job posting or promoted job posting, may be selected for presentation in a prominent position within the search results that are presented to the job-seeking member. Alternatively, a paid or promoted job posting may be presented in a format (e.g., bold text, bright colors, etc.) that differs from other job postings, so as to draw attention to the paid or promoted job posting. Similarly, when job postings are recommended to a job-seeking member who may be browsing recommended job postings, a paid or promoted job posting may be selected for presentation in a particular presentation format, or prominent position within several recommended job postings. Additionally, a paid or promoted job posting may be brought to the attention of certain job-seeking members via email, mobile application notifications, or other communication channels. Importantly, a paid or promoted job posting is generally subject to some additional beneficial processing, whereas free or non-paid job postings, referred to herein as organic job postings, are not subject to the same beneficial processing as their promoted counterparts.

### BRIEF DESCRIPTION OF THE DRAWINGS

Embodiments of the present invention are illustrated by way of example and not limitation in the figures of the accompanying drawings, in which:

FIG. 1 is a system diagram illustrating how conventional selection and ranking algorithms may be used in a process for generating a list of job postings for presentation to a job-seeking member of an online job hosting service;

FIG. 2 is a system diagram illustrating a data processing pipeline or technique that uses a targeting scheme, consistent with embodiments of the present invention, for generating a list of job postings, including one or more promoted job postings;

FIG. 3 is a diagram illustrating an example of how historical data relating to confirmed hires may be processed to generate an implicit facet framework for which a plurality of implicit facets map members to job postings, consistent with embodiments of the invention;

FIG. 4 is a diagram showing an example of an implicit facet derived from analyzing and processing data relating to confirmed hires, consistent with embodiments of the invention;

FIG. 5 is diagram illustrating an example of a table that is used for inventory forecasting, consistent with embodiments of the invention;

FIG. 6 is a diagram showing an example of a job posting flow, consistent with embodiments of the invention;

FIG. 7 is a diagram showing an example of how a member request for job postings may be processed using the implicit facet framework, consistent with embodiments of the invention;

FIG. 8 is a block diagram illustrating a software architecture, which can be installed on any of a variety of computing devices to perform methods consistent with those described herein; and,

FIG. 9 illustrates a diagrammatic representation of a machine in the form of a computer system within which a set of instructions may be executed for causing the machine to perform any one or more of the methodologies discussed herein, according to an example embodiment.

### DETAILED DESCRIPTION

Described herein are methods and systems to facilitate a data processing framework and technique for use in matching an online job posting with member profiles of members of a job hosting service, and for use in matching a member profile of a member with one or more paid or promoted online job postings. In the following description, for purposes of explanation, numerous specific details and features are set forth in order to provide a thorough understanding of the various aspects of different embodiments of the present invention. It will be evident, however, to one skilled in the art, that the present invention may be practiced and/or implemented with varying combinations of the many details and features presented herein.

For purposes of the present disclosure, a member of an online service is an end-user of the online service. End-users, or members, who generate job postings are referred to herein as job-posting members, or simply job-posters, whereas members who are seeking employment opportunities by browsing, searching for, or otherwise reviewing online job postings are referred to herein as job-seeking members or simply, job-seekers.

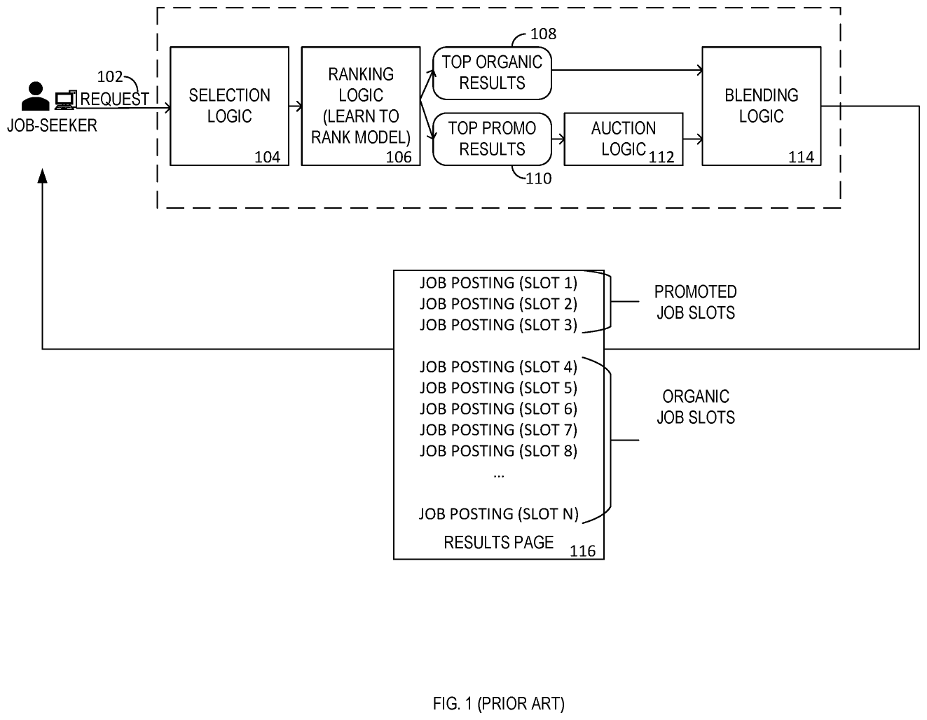

With many conventional online job hosting services, a job-seeker who is actively searching for a job opportunity may utilize a website that provides a search engine to perform a search for job postings by specifying a search query including one or more keywords for the search. Similarly, a job-seeker may invoke a request to view a list of recommended job postings, as generated by a job recommendation service. In either case, when a request to present job postings to a particular job-seeking member is received at the online job hosting service, the request may be processed by the online job hosting service in two stages. For example, as illustrated in FIG. 1, a request 102 received from a computing device of a job-seeking member may first be processed by selection logic 104, which executes a query against a job posting database to retrieve an initial set of job postings. Typically, the selection logic 104 is implemented to perform a high recall, low precision query. For example, the query may return thousands, or even tens of thousands, of job postings, of which many are not particularly relevant with respect to the request. Accordingly, in a second stage, referred to as a ranking stage, the job postings identified at the initial selection stage are subsequently subject to ranking logic 106, which generates a ranking score for each job posting. Accordingly, some subset of high-ranking job postings will ultimately be selected for presentation to the member.

As shown in FIG. 1, many conventional job hosting services have a single data processing flow for selection 104 and ranking 106 to generate job postings for both organic job postings as well as paid or promoted job postings. In this context, the term “organic job posting” is used in reference to a free or unpaid job posting, and is meant to differentiate from a job posting that is a paid or promoted job posting, which, for example, may be subject to a pay-for-performance model. As illustrated in FIG. 1, the ranked list of job postings output by the ranking logic 106 is divided into a set of high-ranking organic job postings (e.g., “top organic results” 108) and a set of high-ranking paid or promoted job postings (e.g., “top promo results 110”). The set of promoted job postings 110 is then provided as input to an auction process via auction logic 112. Finally, the top paid job postings selected via the auction logic 112 are mixed or blended, by blending logic 114, with the top organic job postings 108 to generate a final listing of job postings 116 that is presented to the job-seeking member. As shown in FIG. 1, the final listing of job postings 116 is presented such that some number of promoted job postings are positioned at the top of the list in what are referred to as promoted job slots, while some subset of the organic job postings are presented in organic job slots, positioned beneath the promoted job slots. However, in other instances, the promoted job slots may have different positions relative to the organic job slots, for example, such that the promoted job postings may be intermixed with the organic job postings.

The conventional selection and ranking technique as described in connection with FIG. 1 is problematic for a variety of reasons, particularly as applied to paid or promoted job postings that are subject to a pay-for-performance model. First, when job postings are subject to a pay-for-performance model, the member who is paying to have the online job hosting service host the paid or promoted job posting will generally desire to know, at the time of creating the job posting, the specific nature of any benefit that the person or organization will receive in exchange for paying to promote the job posting. This is particularly true when the person or organization might, as an alternative to paying to promote the job posting, submit the job posting as an organic job posting (e.g., paying no fee). For example, before paying to promote an online job posting, a person or organization submitting an online job posting to a job hosting service may want to know the characteristics of the expected target audience, as well as the size of the expected target audience—that is, the number of members to whom the promoted job posting might be presented. Similarly, the person or organization creating a job posting may desire to know the number of expected job applicants that the job posting is likely to generate, and the timing—for example, how long it will take for some number of members to apply for the job described in the promoted job posting. From the perspective of the entity operating the online job hosting service, providing this type of information to the person or organization submitting the job posting is extremely beneficial, as this information can be very persuasive in convincing the job-poster to pay to promote a job posting. Therefore, from the perspective of the entity operating the job hosting service, it is not only beneficial to present this type of information, but particularly to present this information as early in the job posting process as is practical—for example, during the job posting flow when the person creating the job posting is being prompted for information about the job.

However, due to the nature of the conventional selection and ranking algorithms, as described above in connection with the description of FIG. 1, the entity operating the job hosting service cannot practically, and accurately, generate the type of information that a person or organization submitting a job posting desires to have. For example, many conventional ranking algorithms utilize a machine learning technique frequently referred to as learning-to-rank, where the importance of the various member attributes and job attributes that impact the ranking of each job posting, for a particular member request, are systematically learned via processing large amounts of training data. These machine-learned ranking algorithms are frequently described as black boxes, as one can only observe and explain the inputs and outputs, but not the inner workings of the logic that processes the input to generate the output. Because of the way these machine-learned models operate, there is no easy way to provide a person or organization submitting a job posting with information to explain the likely characteristics, or quality, of the job applicants that are likely to result from a particular online job posting. Moreover, with the conventional technique described in connection with FIG. 1, there is no easy way to predict the number of qualified members who may access the job hosting service and therefore be presented with the job posting—a task commonly known as inventory forecasting. Without the ability to accurately predict the number of qualified members to whom a promoted job posting might be presented, it is difficult if not impossible to accurately estimate or predict the number of job applications that a promoted job posting might be expected to generate. As such, using a selection and ranking technique like that described in connection with FIG. 1 is problematic because such techniques do not allow the entity operating the online job hosting service to generate information that is useful in sharing with persons and/or organizations who might want to pay to promote an online job posting.

Another problem with many conventional selection and ranking techniques, such as that described in connection with FIG. 1, is that the same algorithm or technique is used to generate job postings for both types of job postings—that is, promoted job postings as well as organic job postings. This is problematic for several reasons. First, it may be desirable to have different criteria for selecting promoted job postings to present to a member, as compared to the criteria used to select organic job postings for presentation to a member. By way of example, with organic job postings, it may be acceptable to present one or more organic job postings that have the best overall ranking score, without regard for whether the ranking score for a particular job posting exceeds some threshold score that is used to determine that a member is qualified for the job posting. In contrast, with paid or promoted job postings, it may be desirable to present a paid or promoted job posting to a member only when the member has certain characteristics that indicate the member is actually qualified for the job described in the job posting. Accordingly, the best selection and ranking algorithm for organic job postings may not be the best selection and ranking algorithm for paid or promoted job postings. However, when the selection and ranking algorithm is shared in common for both types of job postings, as illustrated in FIG. 1, it may be impossible to optimize the selection algorithm for one type of job posting without having an adverse effect on the performance of the algorithm for the other type of job posting.

Consistent with embodiments of the present invention, an improved selection technique—referred to as a targeting technique—is provided for use with paid or promoted job postings. Using the technique presented herein, when a person is creating a job posting, that person may be prompted to pay to promote the job posting, while being presented with accurate information reflecting various characteristics of the qualified candidate pool, the size of the qualified candidate pool, and in some instances, the size of the expected target audience. As described in greater detail below, for any promoted job posting, the qualified candidate pool is a group of members determined via a graph (e.g., a member profile-to-job posting graph), which uses matching logic, referred to herein as implicit facets, and in some instances keywords used in search queries, to map member profiles to job postings. Accordingly, the qualified candidate pool is the group of members who, by virtue of their member profile attributes and search keywords, are linked to a promoted job posting via an implicit facet. However, as not all members are actively logging into and using the online service, the expected target audience for a promoted job posting is generally a subset of the qualified candidate pool, determined in part through a process referred to herein as inventory forecasting. Through the process of inventory forecasting, the size of the expected target audience—that is, the number of members to whom the job posting might be presented, if the job posting is promoted—can be accurately determined. Additionally, through inventory forecasting, the expected number of job applications that the job posting is likely to generate, if promoted, can be accurately estimated. Advantageously, the information relating to the expected target audience can be presented to the job-poster, during the job posting flow, and is derived based on a combination of the targeting framework and inventory forecasting, as described in greater detail below.

First, a member profile-to-job posting graph is derived, offline, for mapping member profiles of members of an online service to job postings hosted by the online service. The graph is derived by generating what are referred to herein as implicit facets. Each individual implicit facet represents matching logic for matching member profiles to job postings. Each individual implicit facet is comprised of a combination of member profile attributes that are linked with a corresponding combination of job attributes. As such, when a member profile of a member has member profile attributes that correspond with or match the member profile attributes of a particular implicit facet, that member will be mapped to all of the job postings that have job attributes that correspond with or match the job attributes of the implicit facet.

Consider an example of an individual implicit facet, as shown immediately below, linking a combination of various member profile attributes and attribute values to a combination of job attributes and attribute values:

IMPLICIT FACET

| MEMBER PROFILE ATTRIBUTES | | JOB ATTRIBUTES |
|---|---|---|
| [MemTitle = Data Scientist] | < == > | [JobTitle = Machine Learning Engineer] |
| [MemCompany = ACME Widgets] | | [JobCompany = Macrosoft Inc.] |
| [MemSkill = Machine Learning] | | [JobSkill = Machine Learning] |

In this example, each attribute begins with a series of letters to indicate the attribute type. For example, a member profile attribute begins with the letters, “Mem” for “Member Profile Attribute,” whereas the job attributes begin with the letters, “Job” to indicate that the attribute is a job attribute. As evidenced by the symbol, “<==>”, the combination of member profile attributes and corresponding member profile attribute values, as shown on the left, are linked to the combination of job attributes and corresponding job attribute values, as shown on the right. Each attribute has a corresponding attribute value. For instance, in the example above, the attribute “MemTitle” is a member profile attribute (e.g., attribute type) and has the attribute value, “Data Scientist.”

Each individual facet maps one or more member profiles to one or more promoted job postings, via the combination of the linked attributes specified by the implicit facet. For example, any member who has a member profile with member profile attributes and corresponding values that match the member profile attributes and attribute values of a particular implicit facet will be mapped to or linked with that particular implicit facet, and thus mapped to or linked with any promoted job posting that has job attributes and attribute values that match the job attributes and attribute values of the particular implicit facet. Referring again to the example implicit facet shown above, if a member has a member profile indicating the member is skilled in machine learning, and currently employed at ACME Widgets with job title, “Data Scientist,” that member would be mapped to or linked with any promoted job postings that are mapped to the implicit facet. Similarly, a job posting for the company, Macrosoft, Inc, with job title, “Machine Learning Engineer” and desired skill, “Machine Learning” would map to all member profiles that are linked with the implicit facet.

In some instances, individual member profile attributes in the group of profile attributes for a particular implicit facet will match or intuitively correspond with a counterpart job attribute in the group of job attributes for the implicit facet. For instance, in the example above, the member profile attribute, “MemSkill” with corresponding attribute value, “Machine Learning” intuitively corresponds with the job attribute, “JobSkill” with the exact same attribute value, “Machine Learning.” One might expect a person having the skill, “Machine Learning” to be a qualified candidate for a job that requires that particular skill. However, in many instances, a member profile attribute in a group of member profile attributes for an implicit facet may have an attribute value that does not match or intuitively correspond with a counterpart attribute value in the group of job attributes for the implicit facet. For instance, again referring to the example implicit facet above, the member profile attribute “MemTitle” with corresponding attribute value, “Data Scientist” does not match the attribute value, “Machine Learning Engineer,” for the job attribute “JobTitle.”

Consistent with some embodiments, the member profile-to-job posting graph that maps the member profiles of members to job postings may have hundreds, or even thousands of individual implicit facets. Via the graph, each member profile may be mapped to one or more individual implicit facets, and each job posting may map to one or more implicit facets. As described in greater detail below, with some embodiments, the combination of linked attributes and corresponding attribute values that comprise each individual implicit facet are arrived at through a process of data mining, and in some instances machine learning and/or clustering algorithms, using as input, data relating to confirmed hires. In this context, a confirmed hire occurs when confirmation is obtained that a member, associated with a particular member profile, has accepted a job or position that corresponds with an online job posting. Accordingly, each confirmed hire can be represented as a pairing of a member profile, with all of its member profile attributes, and a job posting, with all of its job attributes, at a particular point in time when the member associated with the member profile was confirmed to have accepted a job described in the job posting. By analyzing, in the aggregate, a significantly large volume of data relating to confirmed hires through a process of data mining machine learning, and/or clustering techniques, patterns within the data can be identified. Specifically, implicit facets can generally be derived based upon identifying within the confirmed hires data (e.g., member profile and job posting pairs) combinations of member profile attributes and corresponding attribute values that frequently co-occur with job attributes and corresponding job attribute values.

Referring again to the example implicit facet set forth above, the linking of the attribute values, “Data Scientist” and “Machine Learning Engineer” for the member profile and job attributes corresponding with the attribute for a job title may result from a pattern identified within the confirmed hires data, where members having the job title, “Data Scientist” are frequently found to have accepted new employment positions with the job title, “Machine Learning Engineer.” While the linking of these two attributes may or may not intuitively make sense, a further example may better illustrate the point. Consider a scenario where, for some unknown and unexplainable reason, members who have the job title, “Senior Engineering Manager” are transitioning to employment positions with the job title, “Zookeeper.” While this may not intuitively make sense, if a significant number of members make this transition, the confirmed hires data will nonetheless reflect this unexpected and perhaps unexplained pattern in member job title transitions. Accordingly, by using a data driven approach that analyzes confirmed hires data to identify groups of corresponding member profile attributes and job attributes, unexpected and unexplained patterns may be identified. In this example, an implicit facet may be derived to include within the group of member profile attributes an attribute for a job title with attribute value, “Senior Engineering Manager,” and a corresponding job attribute for a job title, with attribute value, “Zookeeper.” Accordingly, with some embodiments, the generation of the plurality of implicit facets is the result of a data driven process involving analyses of historical data relating to confirmed hires.

Once the member profile-to-job posting graph has been derived, the relationships between member profiles and promoted job postings, as represented within the graph, are leveraged to generate information about an expected target audience for a new job posting. For example, when a person or organization is creating a new job posting, information about the new job posting can be analyzed to identify the relevant job attributes. Using the job attributes, the new job posting can be mapped to one or more implicit facets. The member profiles that are linked to or associated with the one or more implicit facets represent the qualified candidate pool for the new job posting. As each implicit facet is a combination of member profile attributes and job attributes, the information relating to these attributes can be provided to the person who is creating the new job posting to explain to that person the various characteristics that can be expected of members to whom the promoted job posting will be presented. Furthermore, the size of the qualified candidate pool can easily be obtained via a simple count of member profiles associated with the implicit facets to which the new job posting is linked. As described in greater detail below, the size of the expected target audience—generally, some subset of the qualified candidate pool—can be derived from historical data indicating how frequently members in the qualified candidate pool are invoking requests to view job postings.

Several additional technical advantages arise from generating and utilizing the member profile-to-job posting graph, as described herein. First, consistent with embodiments of the present invention, the member profile-to-job posting graph can be pre-computed. That is, the graph is derived offline, and pre-exists at the time when a particular member makes a request to view recommended job postings, or when a member performs a search for job postings. Because the graph is pre-computed, the latency associated with the candidate generation stage when processing a particular member request is significantly reduced, as compared to the conventional approach, such as that described in connection with the description of FIG. 1.

Additionally, during the job posting flow, when a person is prompted to provide information about a job opportunity via one or more user interfaces, the job hosting service can utilize the pre-computed graph to quickly identify the qualified candidate pool for the promoted job posting. For instance, when the person creating the job posting has provided all of the information for the job described in the job posting, this information can be analyzed to identify the relevant job attributes, and these job attributes can then be used to identify one or more implicit facets to which the job posting can be linked or mapped. Accordingly, the member profiles linked to or associated with the identified one or more implicit facets represent the qualified candidate pool. In some instances, each implicit facet may have associated statistics that are pre-computed, for example, to indicate the number of member profiles and/or job postings that are associated with the implicit facet. Furthermore, as each individual implicit facet is a mapping of some relatively small number of member profile attributes to job attributes, the various attributes and corresponding attribute values that determine the qualified candidate pool can be used to provide an explanation to the job-poster creating the job posting of how or why various members are qualified for the job posting. A variety of other advantages will be apparent from the description of the several figures that follows.

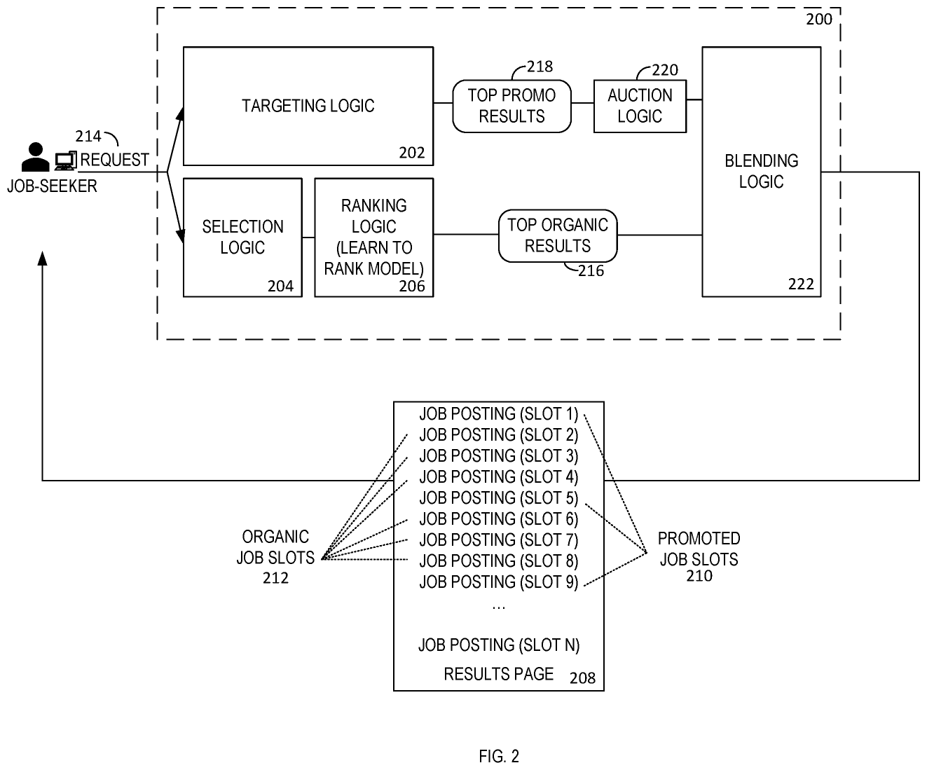

FIG. 2 is a system diagram illustrating a data processing pipeline 200 or technique that uses targeting logic 202, consistent with embodiments of the present invention, for generating a list of job postings 208, including one or more promoted job postings prominently presented in one or more promoted job slots 210. In the data processing pipeline 200 of FIG. 2, the initial request 214 invoked by the job-seeking member is processed in parallel for the purposes of identifying organic job postings 216 and promoted job postings 218. For example, the request 214 is processed by the selection logic 204, and the ranking logic 206, in the manner described above in connection with the description of FIG. 1, to generate a set of top organic results 216 (e.g., high-ranking organic job postings). Simultaneously, the request 214 is separately processed (e.g., in parallel) by the targeting logic 202 to generate a set of top promoted job postings (e.g., top promo results 218), which are then subjected to the auction logic 220, before being mixed or blended, by blending logic 222, with the top organic results 216. The result is a user interface (e.g., results page 208) that presents some number of high-ranking and auction-winning promoted job postings in promoted job slots 210, along with some number of organic job postings presented in organic job slots 212. As shown in FIG. 2, the promoted job slots are shown in the positions designated as job slots 1, 5 and 9, while the job slots indicated as job slots 2, 3, 4, 6, 7, and 8 are shown as organic job slots. In various alternative embodiments, the promoted job slots may be positioned differently within the final list of job postings. For instance, in various embodiments, the blending logic 222 may process a variety of different rules that impact the positioning of the organic job slots in relation to the promoted job slots.

As discussed above, one advantage in separating the selection logic 204 for organic job postings, from the targeting logic 202 for promoted job postings, is that the separate software-based techniques can be individually optimized to meet different metrics and/or requirements. For example, with some embodiments, the targeting logic 202 may be optimized to map members with job postings, based on data relating to confirmed hires or other historical data, whereas the selection and ranking for the organic job postings may be optimized based on a combination of attribute matching and member engagement—that is, the activity level of members at the online service. Accordingly, in various embodiments, the metrics by which the targeting logic 202 and the selection logic 204 are optimized may vary.

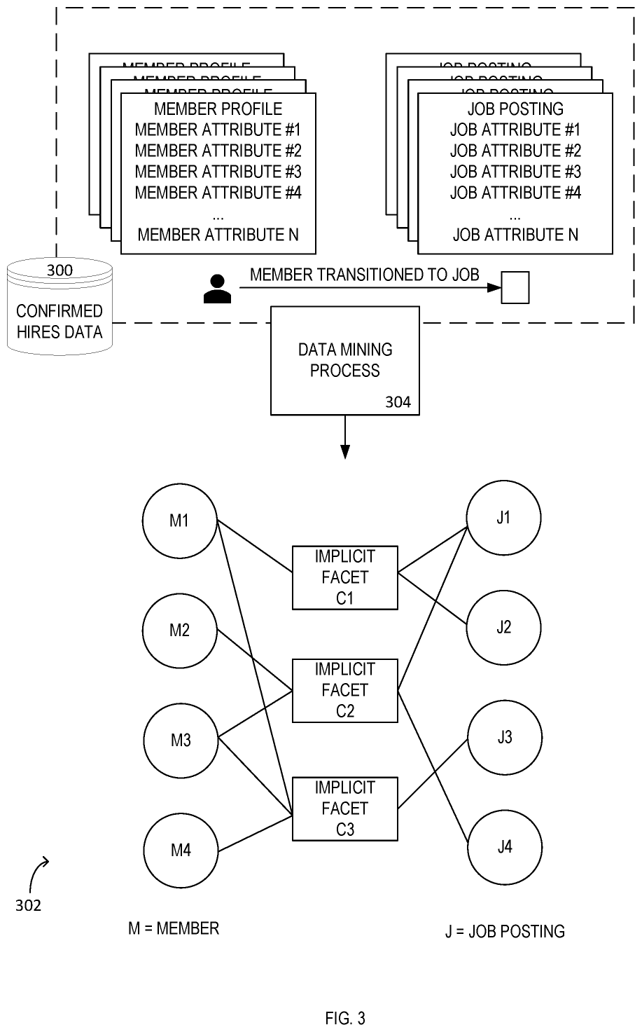

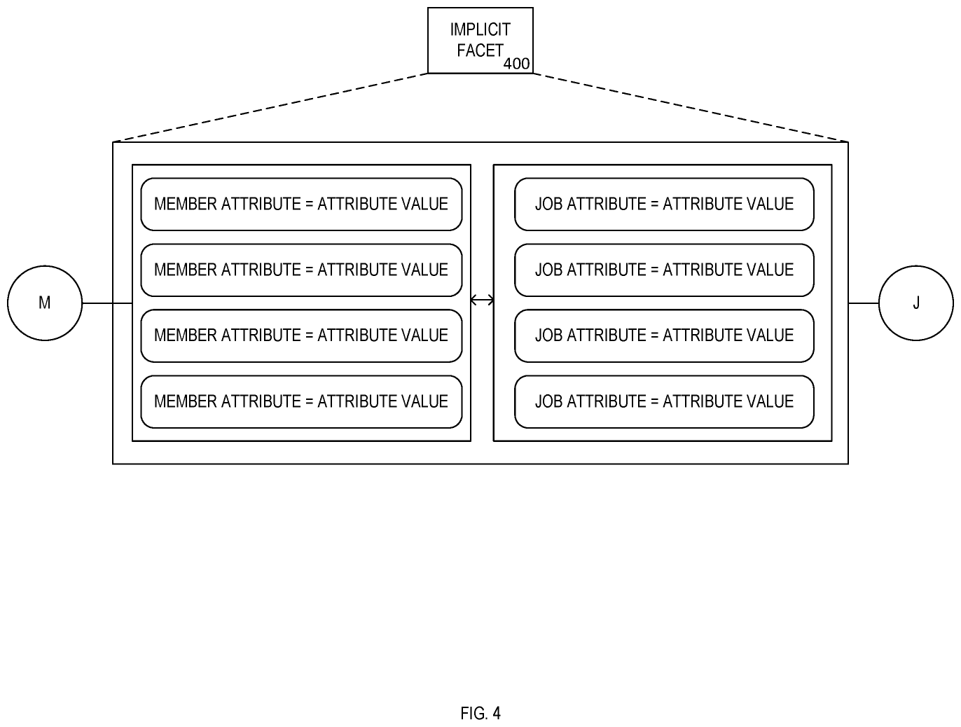

In processing the request 214, the targeting logic 202 uses a member profile-to-job posting graph to identify job postings to which the member has been linked, via the graph. An example of the member profile-to-job posting graph, and how it may be derived, is presented and described in connection with FIGS. 3 and 4, below. By way of example, the received request 214 includes information identifying the member (e.g., a member identifier), which is used to identify one or more implicit facets within the graph to which the member, or more precisely, the member profile of the member has previously been mapped. Any promoted job posting that is linked to or associated with one of the identified implicit facets, via the graph, is then selected as a promoted job posting 218, and is provided to the auction logic 220. The auction logic 220 selects some number of promoted job postings, based on previously provided auction bids. These auction-winning, promoted job postings are then provided to the blending logic 222, which applies one or more rules to generate a results page (e.g., a user interface) that lists the promoted job postings and organic job postings. The rules applied by the blending logic 222 may result in the reordering of job postings, for example, to ensure that job postings are diversified based on various criteria. For example, the blending logic 222 may process a rule to ensure that two promoted job postings are separated by some minimum number of organic job postings. Similarly, the blending logic 22 may include a rule to ensure that similar job postings—for example, job postings associated with the same company, or job postings with similar job titles, and so forth—are not presented immediately next to one another in the final listing of job postings.

FIG. 3 is a diagram illustrating an example of how historical data 300 relating to confirmed hires may be processed to generate a member profile-to-job posting graph 302, including an implicit facet framework for which a plurality of implicit facets map members to job postings, consistent with embodiments of the invention. As illustrated in FIG. 3, confirmed hires data 300 is generally comprised of individual pairings of a member profile and a job posting, where the member associated with the member profile has been confirmed to have accepted a job described in the job posting. As shown in FIG. 3, several individual instances of confirmed hires data 300 (e.g., pairings of a member profile 304 and a job posting 306) are shown. Each individual member profile includes a plurality of member attributes and corresponding attribute values. Similarly, each job posting includes a plurality of job attributes and corresponding attribute values.

In various alternative embodiments, different techniques may be used to analyze and process the confirmed hires data 300 to derive the individual implicit facets (e.g., labeled in FIG. 3 as “C1,” “C2,” and “C3”) that are part of the graph 302. Generally, the objective in formulating the implicit facets is to identify within the confirmed hires data various combinations of attributes and corresponding attribute values that frequently co-occur, for example, such that the combination of member profile attributes and job attributes occur together in pairings of member profiles and job postings of the confirmed hires data at or above some threshold level. To identify these combinations of attributes and corresponding attribute values for each individual implicit facet, any of a number of data processing techniques may be used, to include data mining, machine learning, and data clustering techniques. For instance, as shown in FIG. 3, consistent with some embodiments, data mining techniques 304 may be used to identify various combinations of different member profile attributes and corresponding member profile attribute values that commonly occur with various job attributes and corresponding job attribute values, in the confirmed hires data.

Consistent with some embodiments, to generate individual implicit facets, the member profiles and the job postings associated with the confirmed hires data 300 are first separately analyzed to generate separate clusters for the member profiles, and the job postings. For example, as a result of the initial clustering, clusters of member profiles are determined, with each cluster being associated with a combination of member profile attributes and corresponding attribute values. Similarly, for the job postings associated with the confirmed hires data, the result of the clustering is clusters or groups of job postings with each cluster or group being associated with a combination of job attributes and corresponding values. Once the clustering has been done for the member profiles and the job postings, links or connections between individual clusters (e.g., one group of member profiles and one group of job postings) are formed based on an analysis that determines the number of member profiles within a cluster that are associated with job postings in another cluster. If, for example, the number of member profiles from a member profile cluster linked with job postings in a job cluster exceeds some threshold, this may indicate that members who possess the member profile attributes of the member profile cluster are strong candidates for job postings having job attributes associated with the job profile cluster.

While FIG. 3 shows the implicit facets being derived from confirmed hires data, in other embodiments, the linking of a combination of member profile attributes and job attributes may be derived from other types of data. For instance, the activity data associated with the behavior of recruiters may be logged, such that insights relating to a relationship between a job posting (e.g., as may be associated with a recruiter) and the member profiles of the members to whom a recruiter directs certain activity (e.g., profile views, messaging, and so forth) may be used to infer relationships between member profiles and job postings.

As shown in FIG. 3, the example graph 302 includes three individual implicit facets, labeled as “C1,” “C2,” and “C3.” Of course, in various embodiments, the graph may have any number of implicit facets, and that number may generally depend upon the number of members and job postings being hosted by the online service. Here, in the example graph 302, the letter “C” associated with each implicit facet has been chosen to reflect that each implicit facet is a cluster of linked, groups of attributes derived from the confirmed hires data, and each implicit facet defines a cluster of members—represented in the graph by circles with labels, “M1,” “M2,” “M3,” and “M4”—as well as a cluster of job postings—represented in the graph by circles with labels, “J1,” “J2,” “J3,” and “J4.” By way of example, the graph 302 shows that two members, “M2” and “M3,” are linked to or associated with the implicit facet with label, “C2.” The members, “M2” and “M3,” have member attributes and corresponding attribute values that match the member attributes and values specified by the implicit facet with label, “C2.” Similarly, the job postings represented in the example graph 302 with labels, “J1” and “J4” are linked or mapped to the implicit facet “C2,” indicating that those job postings have attributes that match those specified by the implicit facet “C2.”

Referring now to FIG. 4, an example of an individual implicit facet 400 is shown. In the example of FIG. 4, the implicit facet 400 is comprised of a combination or group of four member profile attributes (indicated in FIG. 4 as “member attributes,” for brevity) and corresponding attribute values, linked with a combination or group of four job attributes and corresponding attribute values. In some instances, a member profile attribute will have an attribute value that matches an attribute value for a corresponding job attribute. However, in other instances, attribute values may not match. For example, a member profile attribute having a value that reflects a member's seniority may correspond with a similar job attribute that has a value reflecting the desired seniority level of a qualified job applicant. In general, the various combinations of attributes—member profile attributes and job attributes—may be discovered or learned by analyzing the confirmed hires data, via data driven techniques. By way of example, different industries may use different job titles for employees who possess generally similar skill sets. Accordingly, if the confirmed hires data reflects a transition of employees from one industry to another, the confirmed hires data may also reflect a transition from one job title (e.g., “Senior Associate”) to a different job title (e.g., “Vice President”). Accordingly, by using a data driven process to analyze the confirmed hires data to generate the combination of attributes specified in each individual implicit facet, the technique may identity patterns or relationships in the confirmed hires data that may not be readily apparent from manual, or human analysis of the data. However, as this data reflects real-world outcomes, as represented in the confirmed hires data, the combination of attributes for each implicit facet can be used to accurately determine the qualified candidate pool for a particular promoted job posting.

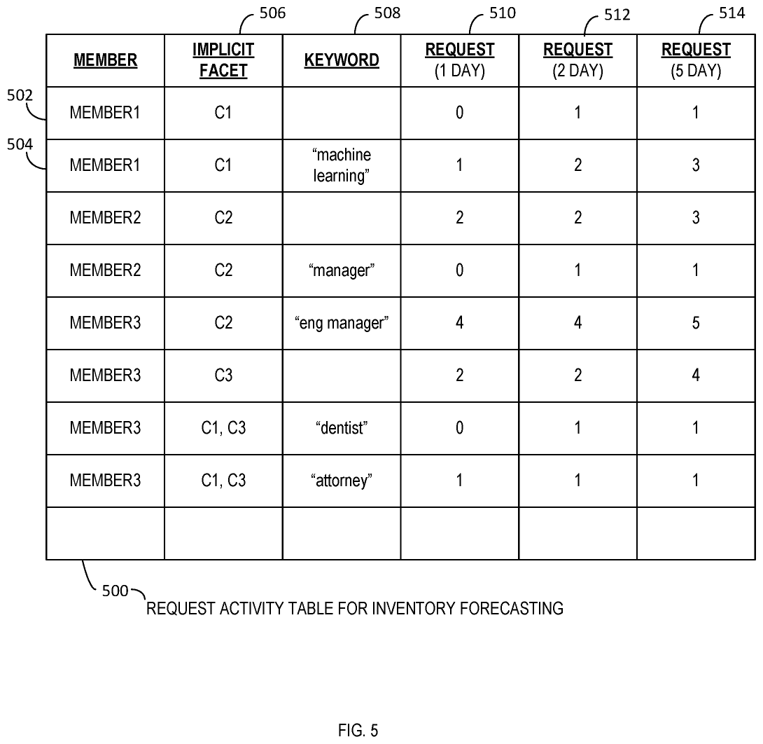

Referring briefly again to FIG. 3, during a job posting flow, for example, when a person is creating a new job posting, the pre-computed graph 302 provides an efficient mechanism for generating information about the qualified candidate pool. For example, information about a job is used to derive job attributes that map the job posting to one or more implicit facets. Subsequently, various member profile attributes associated with each implicit facet can be presented to a person who is creating the new job posting, to reflect characteristics of the qualified candidate pool, and expected job applicants. Furthermore, the graph itself determines the size of the qualified candidate pool, which consists of those member profiles linked, via the graph, to the implicit facets to which the job posting is linked or mapped. Some additional information that may be presented to a person creating a new job posting may involve information about the size of the expected target audience—that is, the number of members in the qualified candidate pool to whom the promoted job posting is likely to be presented, and/or the expected number of job applicants that the promoted job posting will generate, over some duration of time subsequent to when the job posting is initially created. The size of the qualified candidate pool is determined based on a count of all members who have member profiles mapped to an implicit facet with which the promoted job posing is linked. However, not all members in the qualified candidate pool may be actively logging into and using the online job hosting service. Accordingly, the expected target audience—that is, the number of members in any particular qualified candidate pool to whom a particular promoted job posting may be presented—will naturally be some subset of the overall number of members in the qualified candidate pool. Determining this number of members is a process referred to as inventory forecasting. In this context, the term, “inventory” is meant to reflect the amount or number of expected impressions—that is, the number of times a particular promoted job posting is expected to be presented, by the job hosting service, to a member within the qualified candidate pool for the promoted job posting. As illustrated in FIG. 5, consistent with some embodiments, inventory forecasting is achieved via an activity or event logging process, that involves logging information about members who invoke requests via the job hosting service. Then, the logged information, as stored in a request activity table, is used to predict how many times a member within a qualified candidate pool for a particular promoted job posting is expected to make a request over some duration of time.

Referring now to FIG. 5, a table, referred to herein as a request activity table 500, is presented. Consistent with some embodiments, each time a member makes a request to view recommended job postings, information about that member and that request are logged, as reflected in the request activity table 500. Specifically, when a member invokes a request for job postings, the implicit facets to which the member profile of the member is mapped are recorded in the activity table. Similarly, each time a member makes a request involving a search for job postings, information about that member and the corresponding search query (e.g., keywords used in the search query) are logged. Accordingly, using the information logged in the request activity table, inventory forecasting for a new job posting can be achieved, for example, by predicting how many members having certain characteristic (as indicated by the implicit facets to which a member profile is mapped) will make requests in the future, based on the historical information reflected in the request activity table 500.

By way of example, as shown in the request activity table 500, the member, with member identifier “MEMBER1,” previously made a request, as evidenced by the row with reference number 502. This member, “MEMBER1,” has a member profile that maps to the implicit facet designated as “C1” as indicated in column two with heading, “IMPLICIT FACET” 506. The columns with headings, “REQUEST (1 Day),” 510, “REQUEST (2 Day),” 512 and “REQUEST (5 Day),” 514 are updated to reflect the number of requests, consistent with the information reflected for that row, which have been received and processed within a particular time period. For instance, referring again to the row with reference 502, as indicated by the value (e.g., “1”) in column five 512, one request of a member with a member profile mapped to the implicit facet designated as “C1” has been processed and received within the last two days. Similarly, as evidenced by the value (e.g., “1”) in the row with reference 502 at column six, with reference 514, one request of a member with a member profile mapped to the implicit facet designated as “C1” has been processed and received within the last five days.

Referring now to the row with reference number 504 in the request activity table 500, the same member, “MEMBER1” also invoked a request with a search query that included the keyword, “machine learning,” as indicated in column three with heading “KEYWORD” 508. While some relevant requests may be associated with requests to view a listing of recommended job postings, other requests invoked by members may involve a search of job postings, for example, for which the member has specified one or more keywords as part of a search query. Accordingly, as shown in the table 500, the column with the heading, “KEYWORD” is provided to capture and reflect a request that has been received and processed, where the member included a particular keyword as part of a search query.

Consistent with embodiments of the invention, using a table similar to the example table 500 illustrated in FIG. 5, an inventory forecast for a given time period can be easily derived by mapping the qualified candidate pool for a promoted job posting to the relevant rows in the table. For example, if, for a particular promoted job posting, the relevant target audience includes members having characteristics that correspond with one or more rows in the table 500, then the inventory forecast for that particular qualified candidate pool can be derived by simply summing the values in the relevant columns that indicate the number of requests that have been received and processed over some previous duration of time. In the example table 500, the relevant columns are those with reference numbers 510, 512 and 514, which are provided to indicate the number of requests received and/or processed in the last one day, two days, or five days, respectively. In various alternative embodiments, columns in a table may be provided to capture the number of member requests over different periods of time—other than those shown in the example table 500 of FIG. 5.

Consistent with some embodiments, the historical information reflected in the request activity table 500 may be used, in combination with other information, to derive the size of the expected target audience—that is, the expected number of impressions or opportunities to present a particular promoted job posting to a member in the qualified candidate pool for that promoted job posting. For example, in an auction-based system, where a job-posting member provides a bid amount and competes, via auction, against others for winning the opportunity to have a promoted job posting presented to a member of a qualified candidate pool, the bid amount will also impact the inventory forecast, and ultimately the size of the expected target audience. Therefore, at least with some embodiments, the historical information reflected in the request activity table may be one of several data inputs to an algorithm that calculates or determines the inventory forecast for a particular promoted job posting.

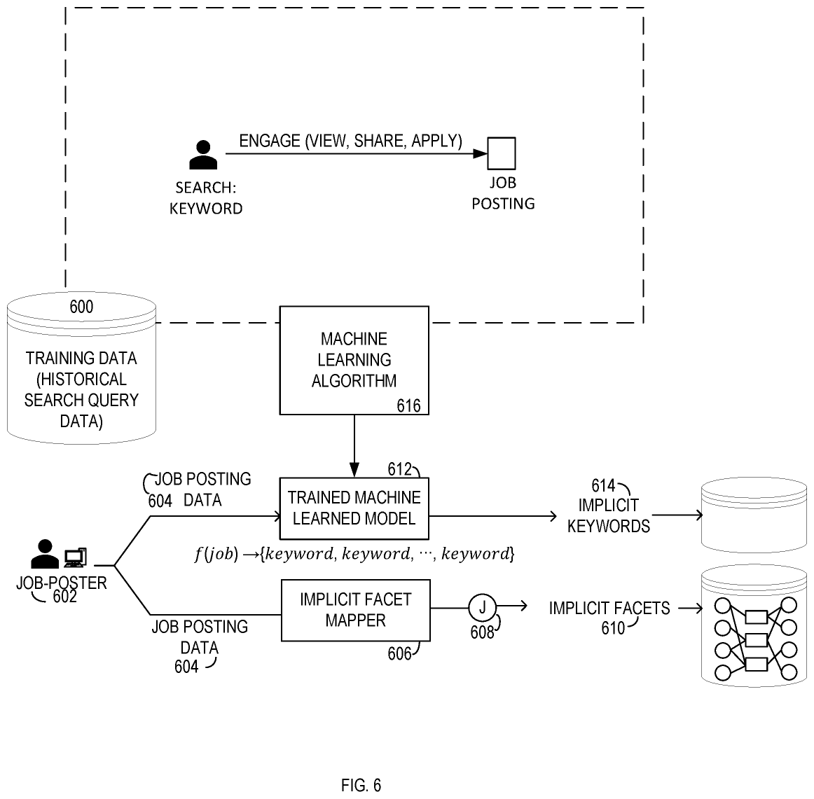

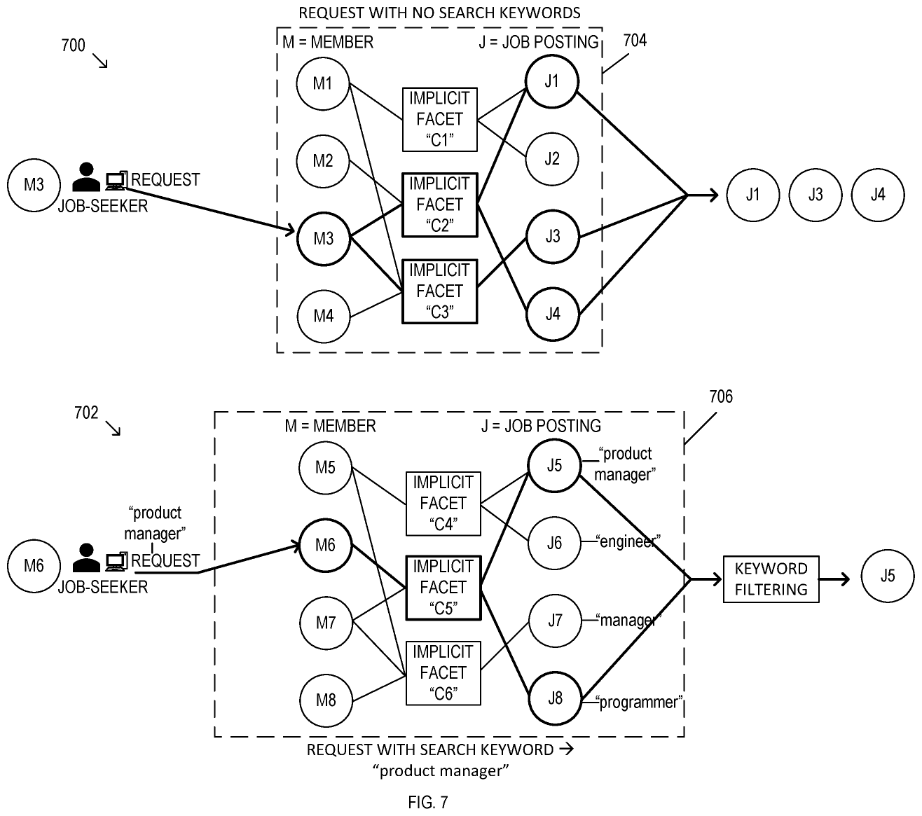

While implicit facets provide a mechanism to map member profiles to relevant promoted job postings via the linking of member profile attributes and job attributes, in many instances, a member's activity may also be important in determining relevant job postings for a member. Specifically, a member's search activity as evidenced by the particular search queries that a member uses in performing searches for job postings can be important information in recommending promoted job postings to the member. For example, in specific instances, certain members may be looking to make a career change, such that the transition that the member is hoping to make may be considered unconventional. For instance, whereas it may be conventional for a person employed as a software engineer (e.g., as a job title) to a first new job position as a senior software engineer, followed by a second transition to a job position as a data scientist, and so on, it may be considered less conventional or even unconventional for a member to transition from a job position as a software engineer, to a job position as a dentist or zookeeper. Accordingly, for this reason and others, in addition to matching member profile attributes to job attributes for purposes of recommending relevant job postings, it is also important to consider a member's search history. FIGS. 6 and 7, illustrate, in part, how implicit keywords can be assigned to new, promoted job postings, and then subsequently used to map member profiles to promoted job postings, based on a member's search.

Referring now to FIG. 6, an example of a job posting flow consistent with embodiments of the present invention is shown. When a person or organization is creating a new job posting, the information provided about the job is analyzed to derive a set of job attributes by which the job posting is then mapped to one or more implicit facets. As shown in FIG. 6, a job-poster 602 provides job posting data 604 relating to the job for which the job posting is being created. This job posting data 604 is analyzed and processed to generate job attributes by which the job posting 608 can be mapped or linked to one or more implicit facets 610. With some embodiments, the job posting data 604, which may be received as raw text information, is first converted to a plurality of standardized job attributes associated with a taxonomy of standardized attributes. Then, using these standardized job attributes, the job posting 608 can be mapped, for example, by the implicit facet mapper 508, to one or more implicit facets, and using the implicit facets, information about the qualified candidate pool can be derived. Specifically, information relating to the characteristics and qualifications of members in the qualified candidate pool can be derived from the various member profile attributes of the one or more implicit facets. Additionally, the size of the qualified candidate pool can be determined by simply obtaining a count of the number of members who are linked to the implicit facets, by virtue of having member profiles with member profiles attributes that map to the one or more implicit facets with which the job attributes of the new job posting are linked.

In addition to mapping the new job posting 608 to one or more implicit facets 610 in the member profile-to-job posting graph, the job posting data 604 is provided as input to a trained machine learned model 612, which uses the input data to predict one or more keywords 614 that members will use when searching for the job posting 608. In some instances, the job posting data may be converted from raw text data to standardized job attributes, prior to being provided as input to the trained machine learned model 612. In any case, the keywords 614, predicted or output by the trained machine learned model 612, are then stored in association with the job posting as what are referred to as implicit keywords 614. The implicit keywords 614 are subsequently used to filter promoted job postings when processing member requests that involve keywords extracted from search queries, as described in greater detail below in connection with the description of FIG. 7. In various alternative embodiments, the number of implicated keywords generated for each job posting may vary.

As shown in FIG. 6, historical data 600 representing previous search queries of members is used as the training data to train the machine learned model 612 with a machine learning algorithm 616. For instance, with some embodiments, historical data 600 pertaining to search queries performed by members who engaged with the search results generated by specific search queries may be logged, and then subsequently used as training data to train a machine learned model 612. For instance, if a member searched for “software engineer,” and then ultimately selected a job posting for viewing, shared a job posting, or applied to a job described in a job posting, these engagement activities are logged, so that the resulting data can be used as training data in predicting keywords that may be used in subsequent searches for other job postings. Accordingly, the machine learned model 612 may be trained to predict one or more keywords that are likely to be used by a member performing a search for a promoted job posting, based on relationships between previously performed searches and job attributes of jobs. As such, the machine learning algorithm 616 may be a supervised machine learning algorithm that uses linear regression to train the machine learned model 612. When a new job posting is being created, the job attributes of the job posting are provided as input to the trained machine learning model 612, which generates implicit keywords as output. Here, the keywords are referred to as “implicit” to signify that they have been predicted to be used in a search for the job posting.

FIG. 7 is a diagram showing an example of how a member request for job postings may be processed using the implicit facet framework, consistent with embodiments of the invention. The implicit facet framework, along with the implicit keywords assigned to promoted job postings, can be used in processing member requests. In the context of a request for job postings, as may be received when a member has indicated a desire to view a list of recommended job postings, the request may be received without the member specifying any specific keywords. Alternatively, in the context of a search by a member for job postings, the request may be received with one or more keywords that have been identified and extracted from the search query.

In FIG. 7, the diagram with reference number 700 shows how the implicit facet framework may be used in processing a member request for which there is no keyword associated with the request. As shown in the diagram 700, the member “M3” has invoked a request for job postings. The promoted job postings that are relevant to the member's request are simply those promoted job postings that are mapped to the same implicit facets to which the member's member profile is mapped. Here, as shown in the graph 704, the member profile of the member, “M3” is associated with the implicit facets, “C2” and “C3.” Moreover, the job postings, “J1,” and “J4” are associated with the implicit facet, “C2,” while the job posting, “J3” is associated with the implicit facet, “C3.” Consequently, for this particular member request, three job postings, “J1,” “J3,” and “J4” are selected as the promoted job postings. These promoted job postings may be subject to an auction process, where one or more winners of the auction are ultimately selected for presentation to the member in a promoted job slot, when presenting a list of recommended job postings to the member, “M3.”

In FIG. 7, the diagram with reference number 702 shows how the implicit facet framework may be used in processing a member request for which there is a keyword associated with the request. For instance, in this particular example, the request, invoked by member, “M6,” is associated with a search, where the search query includes the keyword, “product manager.” As shown in the diagram 702, the member profile of the member “M6” maps to the implicit facet, “C5.” In this case, the job postings, “J5” and “J8” are linked or mapped to the implicit facet, “C5.” Therefore, the job postings “J5” and “J8” are considered as potential promoted job postings to be presented to the member. However, the promoted job postings are then filtered to select or include only those job postings associated with or having an implicit keyword that matches or corresponds with the keyword included with the request. In this case, as a result of the filtering, the job posting “J8” is excluded from selection, as the promoted job posting “J8” is not associated with the implicit keyword, “product manager.” Consequently, the promoted job posting “J5,” which is shown to be associated with the implicit keyword, “product manager,” is selected in response to the member's request.

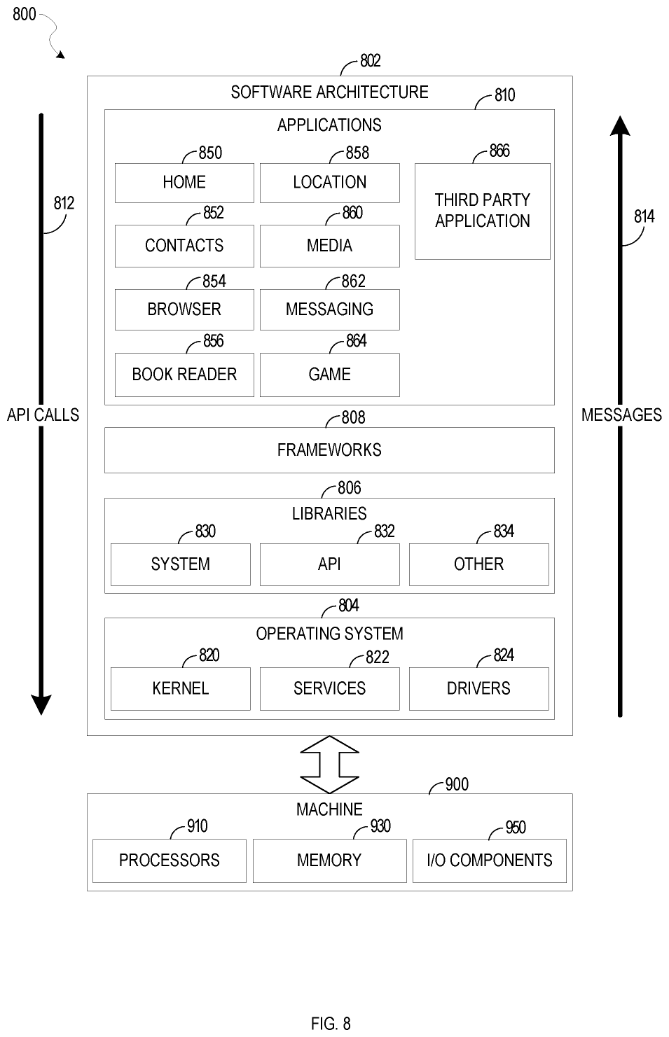

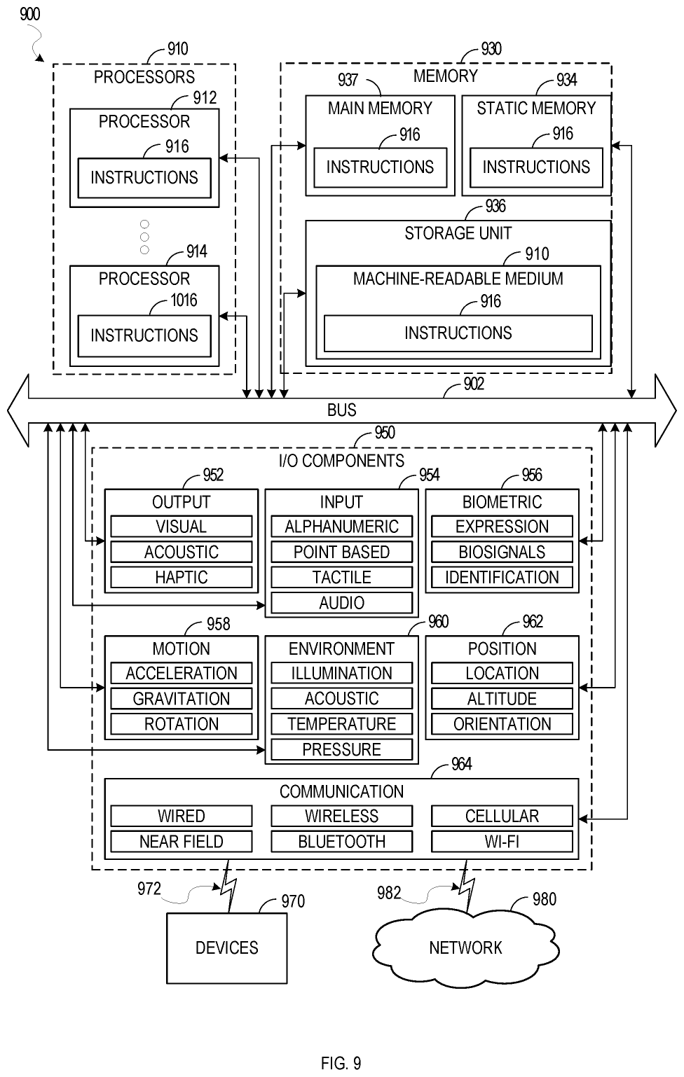

FIG. 8 is a block diagram illustrating a software architecture 802, which can be installed on any of a variety of computing devices to perform methods consistent with those described herein. FIG. 8 is merely a non-limiting example of a software architecture, and it will be appreciated that many other architectures can be implemented to facilitate the functionality described herein. In various embodiments, the software architecture 802 is implemented by hardware such as a machine 900 of FIG. 9 that includes processors 910, memory 930, and input/output (I/O) components 950. In this example architecture, the software architecture 802 can be conceptualized as a stack of layers where each layer may provide a particular functionality. For example, the software architecture 802 includes layers such as an operating system 804, libraries 806, frameworks 808, and applications 810. Operationally, the applications 810 invoke API calls 812 through the software stack and receive messages 814 in response to the API calls 812, consistent with some embodiments.

In various implementations, the operating system 804 manages hardware resources and provides common services. The operating system 804 includes, for example, a kernel 820, services 822, and drivers 824. The kernel 820 acts as an abstraction layer between the hardware and the other software layers, consistent with some embodiments. For example, the kernel 820 provides memory management, processor management (e.g., scheduling), component management, networking, and security settings, among other functionality. The services 822 can provide other common services for the other software layers. The drivers 824 are responsible for controlling or interfacing with the underlying hardware, according to some embodiments. For instance, the drivers 824 can include display drivers, camera drivers, BLUETOOTH® or BLUETOOTH® Low Energy drivers, flash memory drivers, serial communication drivers (e.g., Universal Serial Bus (USB) drivers), Wi-Fi® drivers, audio drivers, power management drivers, and so forth.

In some embodiments, the libraries 806 provide a low-level common infrastructure utilized by the applications 810. The libraries 806 can include system libraries 830 (e.g., C standard library) that can provide functions such as memory allocation functions, string manipulation functions, mathematic functions, and the like. In addition, the libraries 806 can include API libraries 832 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic context on a display), database libraries (e.g., SQLite to provide various relational database functions), web libraries (e.g., WebKit to provide web browsing functionality), and the like. The libraries 806 can also include a wide variety of other libraries 834 to provide many other APIs to the applications 810.

The frameworks 808 provide a high-level common infrastructure that can be utilized by the applications 810, according to some embodiments. For example, the frameworks 808 provide various GUI functions, high-level resource management, high-level location services, and so forth. The frameworks 808 can provide a broad spectrum of other APIs that can be utilized by the applications 810, some of which may be specific to a particular operating system 804 or platform.

In an example embodiment, the applications 810 include a home application 850, a contacts application 852, a browser application 854, a book reader application 856, a location application 858, a media application 860, a messaging application 862, a game application 864, and a broad assortment of other applications, such as a third-party application 866. According to some embodiments, the applications 810 are programs that execute functions defined in the programs. Various programming languages can be employed to create one or more of the applications 810, structured in a variety of manners, such as object-oriented programming languages (e.g., Objective-C, Java, or C++) or procedural programming languages (e.g., C or assembly language). In a specific example, the third-party application 866 (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating system. In this example, the third-party application 866 can invoke the API calls 812 provided by the operating system 804 to facilitate functionality described herein.

FIG. 9 illustrates a diagrammatic representation of a machine 900 in the form of a computer system within which a set of instructions may be executed for causing the machine to perform any one or more of the methodologies discussed herein, according to an example embodiment. Specifically, FIG. 9 shows a diagrammatic representation of the machine 900 in the example form of a computer system, within which instructions 916 (e.g., software, a program, an application, an applet, an app, or other executable code) for causing the machine 900 to perform any one or more of the methodologies discussed herein may be executed. For example the instructions 916 may cause the machine 900 to execute any one of the methods described herein. Additionally, or alternatively, the instructions 916 may implement the systems described in connection with FIG. 2, or any other, and so forth. The instructions 916 transform the general, non-programmed machine 900 into a particular machine 900 programmed to carry out the described and illustrated functions in the manner described. In alternative embodiments, the machine 900 operates as a standalone device or may be coupled (e.g., networked) to other machines. In a networked deployment, the machine 900 may operate in the capacity of a server machine or a client machine in a server-client network environment, or as a peer machine in a peer-to-peer (or distributed) network environment. The machine 900 may comprise, but not be limited to, a server computer, a client computer, a PC, a tablet computer, a laptop computer, a netbook, a set-top box (STB), a PDA, an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 916, sequentially or otherwise, that specify actions to be taken by the machine 900. Further, while only a single machine 900 is illustrated, the term “machine” shall also be taken to include a collection of machines 900 that individually or jointly execute the instructions 1016 to perform any one or more of the methodologies discussed herein.

The machine 900 may include processors 910, memory 930, and I/O components 950, which may be configured to communicate with each other such as via a bus 902. In an example embodiment, the processors 910 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an ASIC, a Radio-Frequency Integrated Circuit (RFIC), another processor, or any suitable combination thereof) may include, for example, a processor 912 and a processor 904 that may execute the instructions 916. The term “processor” is intended to include multi-core processors that may comprise two or more independent processors (sometimes referred to as “cores”) that may execute instructions contemporaneously. Although FIG. 9 shows multiple processors 910, the machine 900 may include a single processor with a single core, a single processor with multiple cores (e.g., a multi-core processor), multiple processors with a single core, multiple processors with multiples cores, or any combination thereof.

The memory 930 may include a main memory 932, a static memory 934, and a storage unit 936, all accessible to the processors 910 such as via the bus 902. The main memory 930, the static memory 934, and storage unit 936 store the instructions 916 embodying any one or more of the methodologies or functions described herein. The instructions 916 may also reside, completely or partially, within the main memory 932, within the static memory 934, within the storage unit 936, within at least one of the processors 910 (e.g., within the processor's cache memory), or any suitable combination thereof, during execution thereof by the machine 900.

The I/O components 950 may include a wide variety of components to receive input, provide output, produce output, transmit information, exchange information, capture measurements, and so on. The specific I/O components 950 that are included in a particular machine will depend on the type of machine. For example, portable machines such as mobile phones will likely include a touch input device or other such input mechanisms, while a headless server machine will likely not include such a touch input device. It will be appreciated that the I/O components 950 may include many other components that are not shown in FIG. 9. The I/O components 950 are grouped according to functionality merely for simplifying the following discussion and the grouping is in no way limiting. In various example embodiments, the I/O components 950 may include output components 952 and input components 954. The output components 952 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 954 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further example embodiments, the I/O components 950 may include biometric components 956, motion components 958, environmental components 960, or position components 962, among a wide array of other components. For example, the biometric components 956 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 1058 may include acceleration sensor components (e.g., accelerometer), gravitation sensor components, rotation sensor components (e.g., gyroscope), and so forth. The environmental components 960 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 962 may include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 950 may include communication components 964 operable to couple the machine 900 to a network 980 or devices 970 via a coupling 982 and a coupling 972, respectively. For example, the communication components 964 may include a network interface component or another suitable device to interface with the network 980. In further examples, the communication components 964 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 970 may be another machine or any of a wide variety of peripheral devices (e.g., a peripheral device coupled via a USB).

Moreover, the communication components 964 may detect identifiers or include components operable to detect identifiers. For example, the communication components 964 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 964, such as location via Internet Protocol (IP) geolocation, location via Wi-Fi® signal triangulation, location via detecting an NFC beacon signal that may indicate a particular location, and so forth.

### Executable Instructions and Machine Storage Medium

The various memories (i.e., 930, 932, 934, and/or memory of the processor(s) 910) and/or storage unit 936 may store one or more sets of instructions and data structures (e.g., software) embodying or utilized by any one or more of the methodologies or functions described herein. These instructions (e.g., the instructions 916), when executed by processor(s) 910, cause various operations to implement the disclosed embodiments.

As used herein, the terms “machine-storage medium,” “device-storage medium,” “computer-storage medium” mean the same thing and may be used interchangeably in this disclosure. The terms refer to a single or multiple storage devices and/or media (e.g., a centralized or distributed database, and/or associated caches and servers) that store executable instructions and/or data. The terms shall accordingly be taken to include, but not be limited to, solid-state memories, and optical and magnetic media, including memory internal or external to processors. Specific examples of machine-storage media, computer-storage media and/or device-storage media include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks. The terms “machine-storage media,” “computer-storage media,” and “device-storage media” specifically exclude carrier waves, modulated data signals, and other such media, at least some of which are covered under the term “signal medium” discussed below.

### Transmission Medium

In various example embodiments, one or more portions of the network 980 may be an ad hoc network, an intranet, an extranet, a VPN, a LAN, a WLAN, a WAN, a WWAN, a MAN, the Internet, a portion of the Internet, a portion of the PSTN, a plain old telephone service (POTS) network, a cellular telephone network, a wireless network, a Wi-Fi® network, another type of network, or a combination of two or more such networks. For example, the network 980 or a portion of the network 1080 may include a wireless or cellular network, and the coupling 982 may be a Code Division Multiple Access (CDMA) connection, a Global System for Mobile communications (GSM) connection, or another type of cellular or wireless coupling. In this example, the coupling 982 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long range protocols, or other data transfer technology.

The instructions 916 may be transmitted or received over the network 980 using a transmission medium via a network interface device (e.g., a network interface component included in the communication components 964) and utilizing any one of a number of well-known transfer protocols (e.g., HTTP). Similarly, the instructions 916 may be transmitted or received using a transmission medium via the coupling 972 (e.g., a peer-to-peer coupling) to the devices 970. The terms “transmission medium” and “signal medium” mean the same thing and may be used interchangeably in this disclosure. The terms “transmission medium” and “signal medium” shall be taken to include any intangible medium that is capable of storing, encoding, or carrying the instructions 916 for execution by the machine 900, and includes digital or analog communications signals or other intangible media to facilitate communication of such software. Hence, the terms “transmission medium” and “signal medium” shall be taken to include any form of modulated data signal, carrier wave, and so forth. The term “modulated data signal” means a signal that has one or more of its characteristics set or changed in such a matter as to encode information in the signal.

### Computer-Readable Medium

The terms “machine-readable medium,” “computer-readable medium” and “device-readable medium” mean the same thing and may be used interchangeably in this disclosure. The terms are defined to include both machine-storage media and transmission media. Thus, the terms include both storage devices/media and carrier waves/modulated data signals.

What is claimed is:

1. A computer-implemented method comprising:
generating a graph mapping a plurality of member profiles of members of an online job hosting service to a plurality of promoted job postings via a plurality of data structures, each data structure comprising a plurality of member profile attributes and corresponding member profile attribute values linked with a plurality of job attributes and corresponding job attribute values;
processing a request to generate a new job posting, by:
receiving data relating to the new job posting;
determining from the data a plurality of job attributes and corresponding job attribute values;
determining a size of a qualified candidate pool for the new job posting by identifying within the graph one or more implicit facets having job attributes and corresponding job attribute values that match the job attributes and corresponding job attribute values of the new job posting, and ii) determining the number of member profiles linked to the identified one or more implicit facets;
presenting via a user interface the size of the qualified candidate pool for the new job posting.

2. The method of claim 1, wherein generating the graph comprises:
deriving an individual implicit facet by identifying within confirmed hires data a plurality of member profile attributes and corresponding member profile attribute values that co-occur with a plurality of job attributes and corresponding job attribute values at a frequency that exceeds a predetermined threshold, wherein each instance of confirmed hires data is a pairing of a member profile of a member and a job posting, for which the member has been confirmed to have accepted a job described in the job posting.

3. The method of claim 2, wherein identifying within confirmed hires data a plurality of member profile attributes and corresponding member profile attribute values that co-occur with a plurality of job attributes and corresponding job attribute values at a frequency that exceeds a predetermined threshold, comprises:
applying a clustering algorithm to the confirmed hires data.

4. The computer-implemented method of claim 1, wherein processing the request to generate the new job posting further comprises:
selecting one or more of the member profile attributes and corresponding member profile attribute values of the identified one or more implicit facets; and
presenting via the user interface one or more of the selected member profile attributes and corresponding member profile attribute values as examples of characteristics of members in the qualified candidate pool to whom the new job posting may be presented, via the online job hosting service.

5. The computer-implemented method of claim 1, wherein processing the request to generate the new job posting further comprises:
deriving an estimate of the size of the expected target audience to whom the new job posting may be presented, by:
querying a database that includes information indicating a count of requests previously received and processed at the online service, over a predetermined duration of time, by members who have member profiles mapped to the identified one or more implicit facets; and
presenting the estimate of the size of the expected target audience via the user interface.

6. The computer-implemented method of claim 5, wherein processing the request to generate the new job posting further comprises:
using the estimate of the size of the expected target audience to derive an estimate of the number of job applications that the new job posting is expected to generate over a predetermined duration of time; and
presenting the number of job applications that the new job posting is expected to generate over a predetermined duration of time via the user interface.

7. The computer-implemented method of claim 1, wherein processing the request to generate the new job posting further comprises:
deriving with a machine learned model one or more implicit keywords for the new job posting, each of the one or more implicit keywords representing a keyword predicted to be used in a search query of a search for the new job posting, wherein the implicit keywords for the new job posting are derived by the machine learned model using as input the plurality of job attributes and corresponding job attribute values.

8. The computer-implemented method of claim 7, further comprising:
receiving a request to identify a plurality of job postings for presentation to a first member of the online job hosting service, wherein the request includes a keyword used in a search query;
selecting a plurality of promoted job postings linked to one or more implicit facets to which a member profile of the first member is linked;
selecting from the plurality of promoted job postings a subset of promoted job postings that are associated with an implicit keyword matching the keyword used in the search query; and
causing the subset of the promoted job postings to be presented to the first member in a user interface along with a plurality of organic job postings.

9. The computer-implemented method of claim 1, further comprising:
receiving a request to identify a plurality of job postings for presentation to a first member of the online job hosting service as recommended job postings;
selecting a plurality of promoted job postings linked to one or more implicit facets to which a member profile of the first member is linked; and
causing a subset of the plurality of selected promoted job postings to be presented to the first member in a user interface along with a plurality of organic job postings.

10. A system comprising:
a processor; and
a computer-readable storage medium storing instructions thereon, which, when executed by the processor, cause the system to:
generate a graph that maps a plurality of member profiles of members of an online job hosting service to a plurality of promoted job postings via a plurality of data structures, each data structure comprising a plurality of member profile attributes and corresponding member profile attribute values linked with a plurality of job attributes and corresponding job attribute values;
processing a request to generate a new job posting, by:
receiving data relating to the new job posting;
determining from the data a plurality of job attributes and corresponding job attribute values; and
determining a size of a qualified candidate pool for the new job posting by i) identifying within the graph one or more implicit facets having job attributes and corresponding job attribute values that match the job attributes and corresponding job attribute values of the new job posting, and ii) determining the number of member profiles linked to the identified one or more implicit facets; and
presenting via a user interface the size of the qualified candidate pool for the new job posting.

11. The system of claim 10, comprising additional instructions, which, when executed by the processor, cause the system to:
derive an individual implicit facet by identifying within confirmed hires data a plurality of member profile attributes and corresponding member profile attribute values that co-occur with a plurality of job attributes and corresponding job attribute values at a frequency that exceeds a predetermined threshold, wherein each instance of confirmed hires data is a pairing of a member profile of a member and a job posting, for which the member has been confirmed to have accepted a job described in the job posting.

12. The system of claim 10, wherein identifying within confirmed hires data a plurality of member profile attributes and corresponding member profile attribute values that co-occur with a plurality of job attributes and corresponding job attribute values at a frequency that exceeds a predetermined threshold, comprises:
applying a clustering algorithm to the confirmed hires data.

13. The system of claim 10, wherein processing the request to generate the new job posting further comprises:
selecting one or more of the member profile attributes and corresponding member profile attribute values of the identified one or more implicit facets; and
presenting via the user interface one or more of the selected member profile attributes and corresponding member profile attribute values as examples of characteristics of members in the qualified candidate pool to whom the new job posting may be presented, via the online job hosting service, if new job posting is promoted.

14. The system of claim 10, wherein processing the request to generate the new job posting further comprises:
deriving an estimate of the size of the expected target audience to whom the new job posting may be presented, if the new job posting is promoted, by:
querying a database that includes information indicating a count of requests previously received and processed at the online service, over a predetermined duration of time, by members who have member profiles mapped to the identified one or more implicit facets; and
presenting the estimate of the size of the expected target audience via the user interface.

15. The system of claim 10, wherein processing the request to generate the new job posting further comprises:
using the estimate of the size of the expected target audience to derive an estimate of the number of job applications that the new job posting is expected to generate over a predetermined duration of time; and
presenting the number of job applications that the new job posting is expected to generate over a predetermined duration of time via the user interface.

16. The system method of claim 10, wherein processing the request to generate the new job posting further comprises:
deriving with a machine learned model one or more implicit keywords for the new job posting, each of the one or more implicit keywords representing a keyword predicted to be used in a search query of a search for the new job posting, wherein the implicit keywords for the new job posting are derived by the machine learned model using as input the plurality of job attributes and corresponding job attribute values.

17. The system of claim 16, comprising additional instructions, which, when executed by the processor, cause the system to:
receive a request to identify a plurality of job postings for presentation to a first member of the online job hosting service, wherein the request includes a keyword used in a search query;
selecting a plurality of promoted job postings linked to one or more implicit facets to which a member profile of the first member is linked;
selecting from the plurality of promoted job postings a subset of promoted job postings that are associated with an implicit keyword matching the keyword used in the search query; and
causing the subset of the promoted job postings to be presented to the first member in a user interface along with a plurality of organic job postings.

18. The computer-implemented method of claim 1, further comprising:
receiving a request to identify a plurality of job postings for presentation to a first member of the online job hosting service as recommended job postings;
selecting a plurality of promoted job postings linked to one or more implicit facets to which a member profile of the first member is linked; and
causing a subset of the plurality of selected promoted job postings to be presented to the first member in a user interface along with a plurality of organic job postings.

19. A system comprising:
means for generating a graph mapping a plurality of member profiles of members of an online job hosting service to a plurality of promoted job postings via a plurality of data structures, each data structure comprising a plurality of member profile attributes and corresponding member profile attribute values linked with a plurality of job attributes and corresponding job attribute values;
means for processing a request to generate a new job posting, by:
receiving data relating to the new job posting;
determining from the data a plurality of job attributes and corresponding job attribute values; and
determining a size of a qualified candidate pool for the new job posting by i) identifying within the graph one or more implicit facets having job attributes and corresponding job attribute values that match the job attributes and corresponding job attribute values of the new job posting, and ii) determining the number of member profiles linked to the identified one or more implicit facets; and
presenting via a user interface the size of the qualified candidate pool for the new job posting.

20. The system of claim 19, further comprising:
means for deriving an individual implicit facet by identifying within confirmed hires data a plurality of member profile attributes and corresponding member profile attribute values that co-occur with a plurality of job attributes and corresponding job attribute values at a frequency that exceeds a predetermined threshold, wherein each instance of confirmed hires data is a pairing of a member profile of a member and a job posting, for which the member has been confirmed to have accepted a job described in the job posting.
